(19) United States
(12) Patent Application Publication
(10) Pub. No.: US 2016/0335089 A1
(43) Pub. Date: Nov. 17, 2016

(54) ELIMINATING REDUNDANCY IN A BRANCH TARGET INSTRUCTION CACHE BY ESTABLISHING ENTRIES USING THE TARGET ADDRESS OF A SUBROUTINE

(71) Applicant: QUALCOMM Incorporated, San Diego, CA (US)

(72) Inventors: Vimal Kodandarama REDDY, Cary, NC (US); Michael William MORROW, Wilkes-Barre, PA (US); Ankita UPRETI, Cary, NC (US); Niket Kumar CHOUDHARY, Raleigh, NC (US)

(21) Appl. No.: 14/709,119

(22) Filed: May 11, 2015

(51) Int. Cl. G06F 9/38

(52) U.S. Cl. CPC G06F 9/3808; G06F 9/3804

(57) ABSTRACT

Indexing subroutine entries in a branch target instruction cache (BTIC) using a target address of the subroutine. The instructions returned by the BTIC may be injected into an execution pipeline to remove a cycle bubble in the processing pipeline.

### BACKGROUND

Aspects disclosed herein relate to the field of pipelined computer microprocessors (also referred to herein as processors). More specifically, aspects disclosed herein relate to processing of branch instructions in processors.

In processing, a pipeline is a set of data processing elements connected in series, where the output of one element is the input of the next one. Instructions are fetched and placed into the pipeline sequentially. In this way multiple instructions can be present in the pipeline as an instruction stream and can be all processed simultaneously, although each instruction will be in a different stage of processing in the stages of the pipeline.

Commonly, when the instruction stream encounters a branch instruction, the pipeline will assume that the program will continue linearly through the instruction stream, not taking the branch. The processor speculatively fetches instructions from memory, to be placed in the pipeline, prospectively before they are needed assuming the branch will not be taken. Of course this assumption may be incorrect and the prospectively fetched instructions may not be needed. In that case the unneeded instructions will be removed, i.e. flushed from the pipeline, and other instructions will need to be fetched to insert into the pipeline. This delay that results from flushing the unneeded instructions and fetching the correct instruction at the branch may introduce a delay commonly called a cycle bubble, fetch bubble, branch taken bubble or branch taken fetch bubble to fetch the instructions at the target address of the branch. For this reason this delay is also referred to as the taken-branch fetch bubble, or fetch bubble.

Branch target instruction caches (BTIC) have been used to remove the fetch bubble. A BTIC is a hardware structure that stores instructions located at the branch target address and inserts the stored instructions into the pipeline on taken branches, if the instructions are in the BTIC. If the instructions are in the BTIC the processor will not have to fetch them from memory and incur the delay encountered in doing so, thereby removing, or at least minimizing the fetch bubble. Entries in a BTIC are traditionally indexed (or “tagged”) using the branch address, and specify the next instructions for insertion in the pipeline to remove or minimize the bubble if the program branch is taken.

However, for subroutines, the number of subroutine calls in program code far outnumbers the number of unique subroutines, leading to the storage of redundant information in the BTIC. In other words, the BTIC would have multiple entries storing the same instructions (corresponding to different locations calling the same subroutine).

### SUMMARY

Aspects disclosed herein establish entries in a branch target instruction cache (BTIC) using subroutine target addresses.

In one aspect, a method comprises detecting a first instruction calling a subroutine in an execution pipeline. The method then establishes a BTIC entry for the subroutine by writing, to the BTIC, an entry specifying a target address of the subroutine and a set of instructions at the target address.

In another aspect, a method comprises detecting a first instruction calling a subroutine in an execution pipeline. A target address of the subroutine is received using an address of an instruction previous to the first instruction. A set of instructions of the subroutine are then received from a BTIC using the target address of the subroutine. The set of instructions are then inserted into the execution pipeline.

In another aspect, a processor comprises a BTIC and logic. The logic is configured to detect a first instruction calling a subroutine in an execution pipeline. The logic is further configured to receive a target address of the subroutine using an address of an instruction previous to the first instruction. The logic is then configured to receive a set of instructions from the BTIC using the target address of the subroutine, and insert the set of instructions into the execution pipeline.

In still another aspect, a non-transitory computer-readable medium stores instructions that, when executed by a processor, cause the processor to detect a first instruction calling a subroutine in an execution pipeline, and establish a BTIC entry for the subroutine. The BTIC entry for the subroutine is established by writing, to the BTIC, an entry specifying the target address of the subroutine and a set of instructions at the target address.

### BRIEF DESCRIPTION OF THE SEVERAL VIEWS OF THE DRAWINGS

So that the manner in which the above recited aspects are attained and can be understood in detail, a more particular description of aspects of the disclosure, briefly summarized above, may be had by reference to the appended drawings.

It is to be noted, however, that the appended drawings illustrate only aspects of this disclosure and are therefore not to be considered limiting of its scope, for the disclosure may admit to other aspects.

FIG. 1 is a functional block diagram of a processor configured to eliminate redundancy in a branch target instruction cache by establishing entries using the target address of a subroutine, according to one aspect.

FIG. 2 illustrates the population and subsequent access of a call target cache and branch target instruction cache, according to one aspect.

FIG. 3 is a logical view of a processor configured to eliminate redundancy in a branch target instruction cache by establishing entries using the target address of a subroutine, according to one aspect.

FIG. 4 illustrates techniques to establish entries in a branch target instruction cache using the target address of a subroutine, according to one aspect.

FIG. 5 is a flow chart illustrating a method to eliminate redundancy in a branch target instruction cache by establishing entries using the target address of subroutines, according to one aspect.

FIG. 6 is a flow chart illustrating a method to add entries to a call target cache and branch target instruction cache, according to one aspect.

### DETAILED DESCRIPTION

Aspects disclosed herein provide a branch target instruction cache (BTIC) that is tagged (or indexed) using target addresses of branch-and-link instructions. By tagging entries in the BTIC using the target address of branch-and-link instructions, aspects disclosed herein may help eliminate storage of redundant entries in the BTIC with instructions for the same subroutine. In other words, while multiple program locations may call a function or subroutine, aspects disclosed herein create a single entry in the BTIC (indexed by the target address of the function or subroutine), rather than creating an entry in the BTIC for each call to the subroutine.

The terms index and tag are used interchangeably herein and generally refer to a parameter (e.g., a program counter or target address) used to retrieve an entry from a cache. As used herein, the term branch-and-link instruction generally refers to an instruction, such as a subroutine call or function call, that is similar to a branch instruction, but that stores the address of the instruction immediately after the branch as a return address, for example, allowing a subroutine to return to the main body routine after completion. Subroutines are used herein as a reference example of a branch-and-link instruction. However, the techniques described herein may apply equally to any type of program code where multiple sources call a single target routine. Any reference to a subroutine herein should not be considered limiting of the disclosure.

The creation of redundant entries associated with PC-tagged BTIC entries is illustrated with the following example assembly code, where “bl” represents a branch and link instruction:

<_i18n_number_rewrite>:
8388: bl b0ac0 <_{——}wctrans>
8398: bl b0b64 <_{——}towctrans>
83a8: bl b0b64 <_{——}towctrans>
8594: bl b0ac0 <_{——}wctrans>
85a4: bl b0b64 <_{——}towctrans>
85b4: bl b0b64 <_{——}towctrans>
000b0ac0 <_{——}wctrans>:
b0ac0: ldr r3, [pc, #152]
b0ac4: strd r4, [sp, #−24]!
b0ac8: mrc 15, 0, r2, cr13, cr0, {3}
000b0b64 <_{——}towctrans>:
b0b64: cmp r1, #0
b0b68: beq b0bc0
b0b6c: ldr r3, [r1]

As shown, the assembly code includes a plurality of calls to two different subroutines, namely “wctrans” and “towctrans,” having instructions located at memory addresses “b0ac0” and “b0b64,” respectively. Traditional techniques using PC-based indexing would create entries in a BTIC for each call site calling the subroutines. Table 1 depicts an example BTIC tagged by the Program Counter (PC) at the call site for the above example code:

TABLE 1

| PC Tagged | Target Instructions |
|---|---|
| 0x8388 | Ldr, Strd, Mrc |
| 0x8398 | Cmp, Beq, Ldr |
| 0x83A8 | Cmp, Beq, Ldr |
| 0x8594 | Ldr, Strd, Mrc |

As shown, Table 1 includes two entries that specify where the target instructions of each subroutine in the calling code, for a total of four entries. For example, there are two entries for the calls to subroutine wctrans at PC 0x8388 and PC 0x8594, each storing the same instructions (Ldr, Strd, Mrc). Similarly, there are two entries for the calls to subroutine towctrans at PC 0x8398 and PC 0x83A8, each storing the same instructions (Cmp, Beq, Ldr). Because there is limited capacity in the BTIC, such redundant entries are made by overwriting existing entries, which may impact system performance by reducing BTIC hit rates.

However, as noted above, aspects of the disclosure may help eliminate the redundant entries by tagging the BTIC using the target address of the subroutine instead of the PC of the calling program. Table 2 depicts an example BTIC tagged by the target address of each subroutine in the above example code instead of the address of the calling code

TABLE 2

| Target Address | Target Instructions |
|---|---|
| 0xb0ac0 | Ldr, Strd, Mrc |
| 0xb0b64 | Cmp, Beq, Ldr |

As shown, rather than indexing each entry with a PC of a subroutine call, the entries in Table 2 are indexed with a target address of each subroutine. By indexing (or tagging) entries in the BTIC using the target address of the branch taken subroutine instead of tagging the BTIC with the address of the calling program, only a single entry is made for the subroutine, thereby avoiding redundant entries storing the same instructions for each time the subroutine is called. For subsequent calls of the same subroutine, the corresponding instructions may be fetched from the BTIC, using the target address of the subroutine. In some cases, however, the target address of the subroutine may not be available at the beginning of a cycle when the subroutine call is executed, which may delay how quickly the corresponding instructions can be fetched. According to certain aspects, a mechanism may be provided to make the target address of the subroutine available sooner.

For example, in one aspect, a call target cache (CTC) may be used to obtain the target address of a subroutine being called, given a PC of an instruction just prior to a subroutine call. In other words, entries in the CTC may be indexed by the PC of the instruction just prior to the branch instruction and will contain the target address of a branch instruction that follows. Once the CTC has been populated during subroutine calls from various locations in program code, the PC of an instruction prior to a call to the subroutine may match an index in the CTC and the corresponding subroutine target address may be used as an index to retrieve that subroutine's instructions from the BTIC.

The present example uses the previous instruction, prior to the branch, as an index to the CTC for several reasons. One of the reasons is that when the branch is encountered the processor needs to know where to branch to before the branch is taken. The only way this can be done is by providing the branch target address before the actual branch is encountered, hence the instruction before is used as an index so when the branch instruction is encountered, the processor knows where to branch if the branch is to be taken. The processor can also use the subroutine target address, fetched from the CTC, to access the BTIC, which will then provide the next several instructions to the pipeline without the delay of having to go to the branch address to fetch them. The instructions in the BTIC can keep the pipeline going without the fetch bubble encountered when new instructions have to be furnished from a non-sequential branch address.

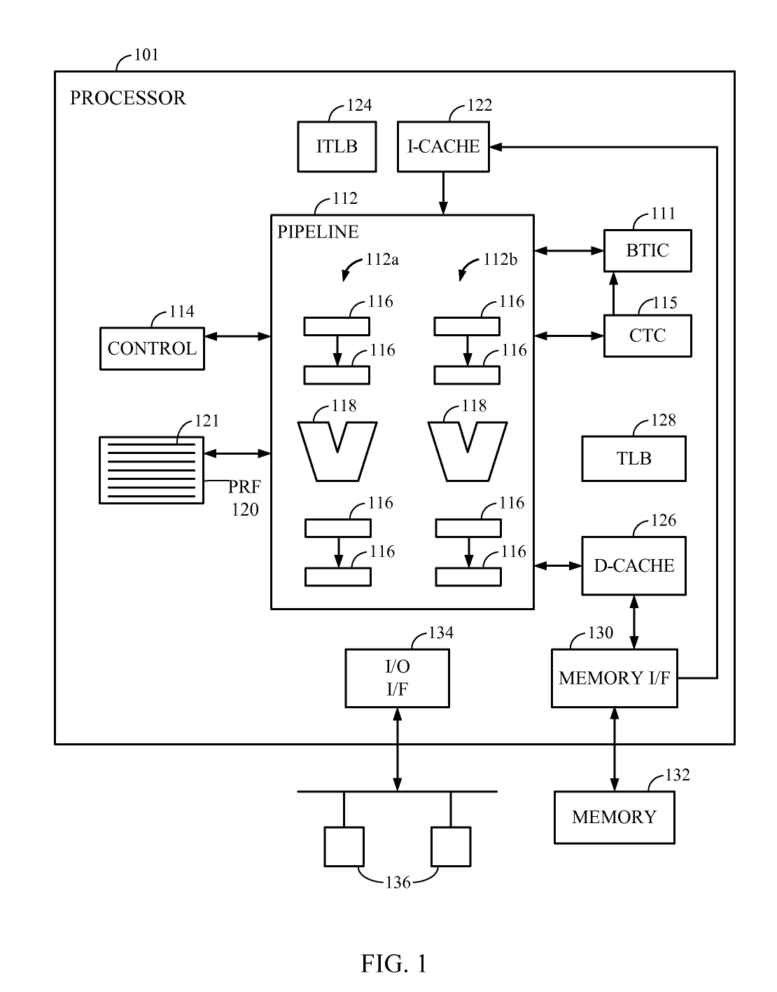

FIG. 1 is a functional block diagram of an example processor 101 configured to eliminate redundancy in a BTIC by establishing entries using the target address of a subroutine, according to one aspect. Generally, the processor 101 may be used in any type of computing device including, without limitation, a desktop computer, a laptop computer, a tablet computer, and a smart phone. Generally, the CPU 101 may include numerous variations, and the CPU 101 shown in FIG. 1 is for illustrative purposes and should not be considered limiting of the disclosure. For example, the CPU 101 may be a graphics processing unit (GPU). In one aspect, the CPU 101 is disposed on an integrated circuit including an instruction execution pipeline 112, a BTIC 111, and a CTC 115.

Generally, the processor 101 executes instructions in an instruction execution pipeline 112 according to control logic 114. The pipeline 112 may be a superscalar design, with multiple parallel pipelines, including, without limitation, parallel pipelines 112a and 112b. The pipelines 112a, 112b include various non-architected registers (or latches) 116, organized in pipe stages, and one or more arithmetic logic units (ALU) 118. A physical register file 120 includes a plurality of architected registers 121.

The pipelines 112a, 112b may fetch instructions from an instruction cache (I-Cache) 122, while an instruction-side translation lookaside buffer (ITLB) 124 may manage memory addressing and permissions. Data may be accessed from a data cache (D-cache) 126, while a main translation lookaside buffer (TLB) 128 may manage memory addressing and permissions. In some aspects, the ITLB 124 may be a copy of a part of the TLB 128. In other aspects, the ITLB 124 and the TLB 128 may be integrated. Similarly, in some aspects, the I-cache 122 and D-cache 126 may be integrated, or unified. Misses in the I-cache 122 and/or the D-cache 126 may cause an access to higher level caches (such as L2 or L3 cache) or main (off-chip) memory 132, which is under the control of a memory interface 130. The processor 101 may include an input/output interface (I/O IF) 134, which may control access to various peripheral devices 136, which may include a wired network interface and/or a wireless interface (e.g., a modem) for a wireless local area network (WLAN) or wireless wide area network (WWAN).

The processor 101 may be configured to employ branch prediction. Branch prediction allows the processor 101 to “guess” which way a branch (e.g., an if-then-else structure) will go before the true branch taken is known. As noted above, the BTIC 111 is a hardware structure that stores instructions at branch targets for insertion into the pipeline 112 if the branch is taken and the address of the branch is present in the BTIC 111. Doing so may avoid delays in the pipeline 112 that may occur when processing is held up by the necessity of fetching (sometimes referred to as “fetch bubbles”), from memory, the instructions at the branch address.

As noted above, entries in the BTIC 111 may be indexed by the target address of branch-and-link instructions (e.g., the subroutine or function called by the branch-and-link instructions). As described above, indexing by the target address rather than the PC of the branch-and-link instruction may help eliminate the storage of redundant information in the BTIC 111. In other words, since all calls to a subroutine, wherever in the program the subroutine is called from, will have the same target address, a single entry in the BTIC 111 may be used to store the instructions for that subroutine.

In some cases, the processor may include a number of different BTICs (not pictured). In one embodiment, the processor 101 may be configured to dynamically adapt between different BTICs 111. For example, a first BTIC 111 may index entries by subroutine target address, while a second BTIC (not pictured) may index entries by branch address. In such an embodiment, the processor 101 may monitor performance of the different types of BTICs. While not shown, the processor may include logic to determine which BTIC provides a greater hit rate (which may be defined as a percentage of times a BTIC has an entry for a given index). For example, as the different BTICs are accessed, the processor 101 may update counters used to track hits or misses. At some point, the processor 101 may dynamically switch to a BTIC having a better hit rate to improve overall processing performance. In some cases, information as to whether a BTIC is accessed for a subroutine call or a branch instruction may be stored, for example, in the CTC 115 as a bit field (not shown). Based on the indication, the processor may access a BTIC indexed based on branch address or a BTIC indexed based on a target address of a subroutine call.

As noted above, the CTC 115 may be configured to store the target address of a subroutine, and is indexed, in one embodiment, by the address of the instruction immediately prior to the branch. The first time a subroutine call from a particular location in program code is encountered in the pipeline 112, logic in the processor 101 creates an entry in the CTC 115 that stores the address of the instruction immediately prior to the subroutine call and the subroutine's target address. If there are no corresponding entries in the BTIC 111, the processor 101 also creates an entry in the BTIC 111 that stores the subroutine's target address and the subroutine's sequential instructions. In at least one aspect, the CTC 115 is implemented as a branch target address cache (BTAC) that may further include branch-target information stored therein, such as whether a corresponding instruction received from the pipeline 112 is a subroutine call. In such aspects, the CTC 115 may provide an indication to the pipeline 112 that the instruction in the pipeline 112 includes a subroutine call, which may prompt the pipeline 112 to access the BTIC 111 to fetch the subroutine's instructions.

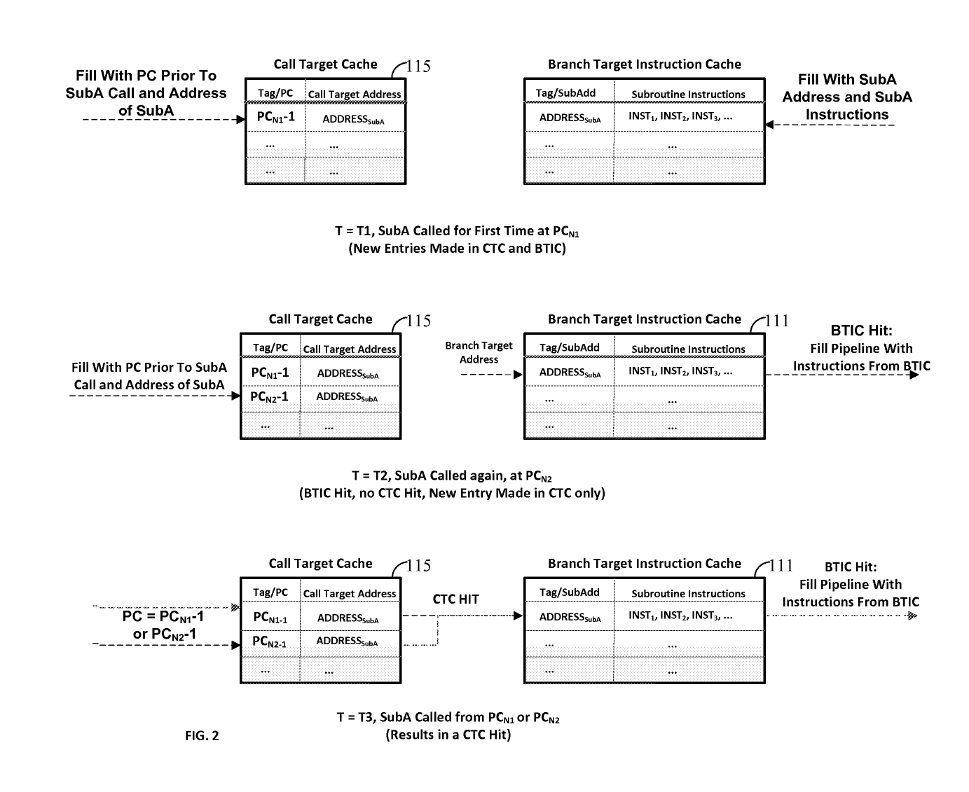

FIG. 2 illustrates how a BTIC 111 and CTC 115 may be populated with corresponding entries during program operation, as subroutines are called from different locations in program code. In some cases, the BTIC 111 and the CTC 115 may be empty when the program is initiated, e.g. booted up. In some cases, the CTC 115 may be initialized (pre-populated), for example, if it is detected that there are many calls at different locations to a same subroutine. The example in FIG. 2, however, assumes the BTIC 111 and CTC 115 are initially empty.

As illustrated, at time T1, a subroutine (SubA in this example) is called for the first time, from a location in program code (PC=PC_{N1}). In this case, the pipelined may be stalled while the instructions of the called routine are fetched, as there is no corresponding entry in the BTIC 111 (a BTIC “miss”). As illustrated, an entry may be made in the CTC for the target address of the subroutine SubA, indexed to the PC of the instruction just prior to the subroutine call (e.g., PC_{N1}−1). Further, the instructions of subroutine SubA may be stored in an entry in the BTIC 111 (indexed to the subroutine target address), such that the instructions may be fetched from the BTIC 111 for subsequent calls to subroutine SubA.

As illustrated, at time T2, subroutine SubA is again called, but this time from a different location in program code (PC=PC_{N2}). In this case, the instructions of subroutine SubA may be fetched from the BTIC 111. However, while there is now an entry in the BTIC 111 for SubA, there may be a slight delay in obtaining the target address of subroutine SubA used to fetch the instructions from the BTIC 111, as the CTC 115 does not yet have an entry corresponding to PC_{N2}. As illustrated, however, this delay may be avoided the next time SubA is called from the same location, by creating an entry in the CTC 115 for the target address of subroutine SubA, indexed to the PC of the instruction just prior to the subroutine call (e.g., PC_{N2}−1).

As illustrated at time T3, a subsequent call to subroutine SubA from either PC_{N1} or PC_{N2} results in a CTC hit and address of subroutine SubA in the corresponding CTC entry may be used to fetch the corresponding instructions from BTIC 111.

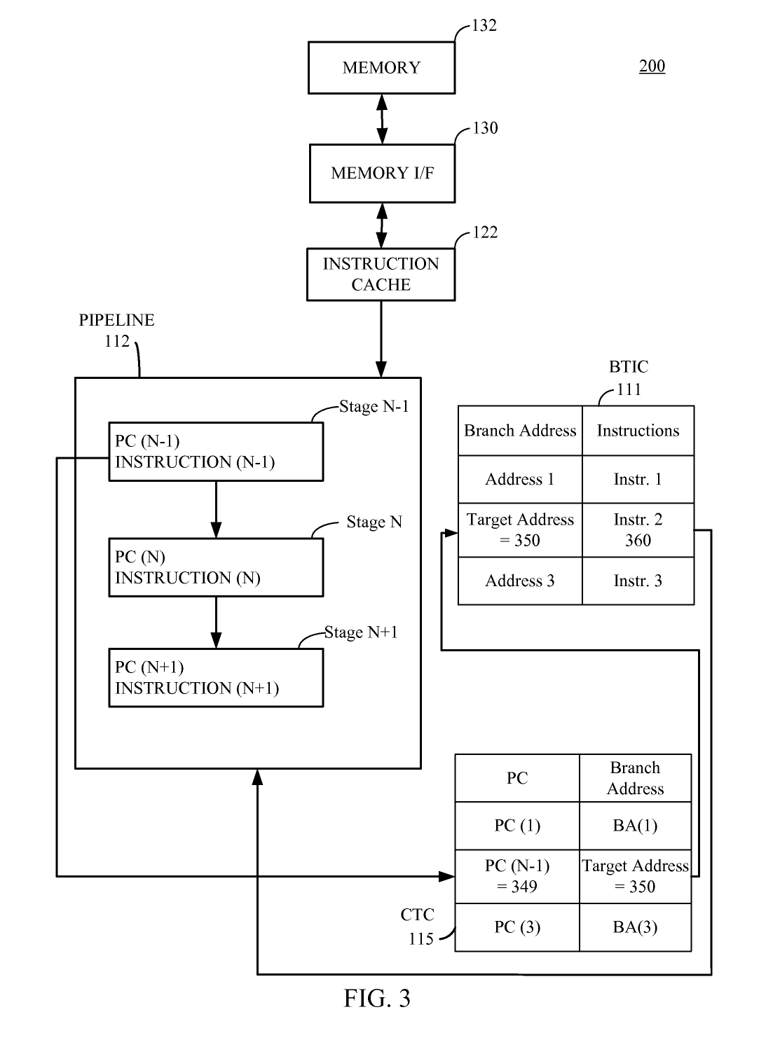

FIG. 3 generally depicts how the pipeline 112 of processor 101 may be configured to establish and use entries in the call target cache (CTC) 115 and the branch target instruction cache (BTIC) 111, in accordance with aspects of the present disclosure.

As shown in FIG. 3, the memory interface 130 speculatively fetches instructions from memory 132. Because the memory interface 130 speculatively fetches instructions, the instructions may be executed and they may not be executed. For example, when a branch occurs, the linear program flow is disrupted and new instructions need to be fetched to replace the linear instructions that would have been executed if the branch had not been taken. Because memory 132 is generally slower than processing speed, the instructions that are speculatively fetched are commonly placed in an instruction cache 122 where there are readily available to the pipeline 112. The pipeline 112 illustratively contains pipeline stages N−1, N, and N+1. For further illustrative purposes, each pipeline stage includes a program counter (PC), which is the address of the instruction that the pipeline stage is executing, and the instruction associated with that program counter. Accordingly PC(N−1) is associated with instruction N−1 of pipeline stage N−1, PC(N) is associated with instruction N of pipeline stage N, and PC(N+1) is associated with instruction N+1 of pipeline stage N+1.

For illustrative purposes, it may be assumed that the BTIC 111 and the CTC 115 include values necessary for functioning of this aspect of the disclosure (e.g., with the example entries illustrated in FIG. 2). It may be further assumed that a branch-and-link instruction, such as a subroutine or function call, is in pipeline stage N. When processing the branch-and-link instruction, the pipeline 112 will check the PC(N−1) against the PC values stored in the index of the CTC 115.

In this example, the value of PC(N−1) is found in the CTC 115 at PC(N−1), resulting in a CTC hit, and the corresponding branch target address (350) can be retrieved. The index value in the CTC 115 for PC(N−1) (349 in this example) is the PC value of the address of the instruction immediately preceding the instruction including the branch-and-link instruction. As illustrated, the branch target address 350 is then used as an index to the BTIC 111. Since the branch instruction target address 350 is in the BTIC 111, the corresponding entry in the BTIC 111 will contain a number of instructions 360 that can be found at the branch target address 350. The instructions 360 at the target address 350 can then be obtained, and provided to the pipeline 112 without having to encounter the delay that would result from having to go to memory 132 to obtain instructions at the target address 350.

In some cases, in order to preserve the addresses that may be used as an index into the CTC 111 and/or BTIC 111, the processor 101 may include a series of latches (not pictured) configured to maintain the appropriate PC values of the instructions previously executed in the pipeline 112. If a branch-and-link instruction is detected in the pipeline 112, these PC values may be stored in the CTC 115.

In some cases, the processor 101 may be configured to detect branch-and-link instructions. In some aspects, the branch-and-link instruction may be detected by an appropriate circuit, such as a subroutine detection circuit (not pictured) of the processor 101. In one aspect, the processor 101 may detect the branch-and-link instructions call via pre-decoding. For example, the instruction cache 122 may pre-decode instructions and determine that an instruction includes a subroutine call. In such a case, the instruction cache 122 may set metadata bits that indicate the instruction includes a subroutine call. In another aspect, the processor 101 may include a branch target address cache (BTAC), which is a tagged structure. When an entry in the BTAC matches a memory address in the program counter, the BTAC may be configured to return instruction data that includes an indication that the instruction includes a branch-and-link instruction, such as a subroutine call. In yet another aspect, the processor 101 may detect the branch-and-link instruction by decoding the instructions in the decode stage of the processing pipeline. Generally, the processor 101 may use any technique to detect a branch-and-link instruction.

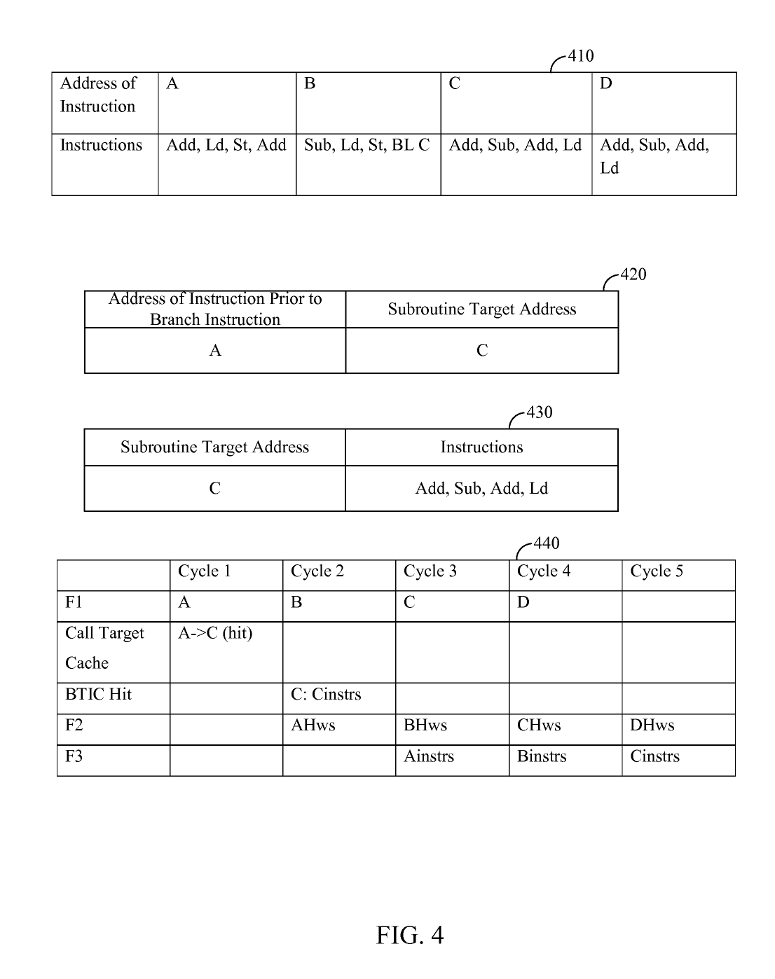

FIG. 4 illustrates techniques to establish entries in a branch target instruction cache using the target address of a subroutine, according to one aspect. Specifically, FIG. 4 depicts a table 410 reflecting sequential program instructions, a table 420 reflecting example values stored in the CTC 115, a table 430 reflecting example entries in the BTIC 111, and a timing diagram 440. The sequential program instructions in table 410 reflect the order in which a processor, such as the processor 101, would execute the instructions at each memory address. Specifically, the program order is of the example memory addresses “A,” “B,” “C,” and “D.” The timing diagram 440 depicts the exemplary instruction sequence of the instructions in the table 410 as the instructions are processed by a processor, such as the processor 101 of FIG. 1.

The columns in the timing diagram 440 each represent a single processor clock cycle. The rows in reflect the execution pipeline stages F1, F2, and F3 during each processor clock cycle. In this example, the row F1 during cycle 1 of the processor indicates that the instructions at address A of table 410 have been fetched. In a similar manner, instructions at addresses B, C, and D will be fetched in cycles 2, 3, and 4, respectively. In this manner, the progression of instructions through the execution pipeline stages over the course of several clock cycles is shown.

As shown in table 410, the instructions at address B include a branch-and-link instruction (in this case a subroutine call), namely the instruction “BL C.” Furthermore, table 420 reflects example values stored in the CTC 115 that have been trained based on at least one previous call to the subroutine C. As shown, therefore, table 420 reflects a CTC 115 specifying A as the PC address of the set of instructions prior to the set of instructions (B) including the branch instruction (the call to subroutine C) and a subroutine target address of C. As shown in table 410, a set (or group) of instructions may include more than one instruction. Therefore, in at least one aspect, the CTC 115 is indexed using the PC value of the first instruction in the set of instructions immediately preceding the set of instructions including the branch-and-link instruction. In addition, table 430 reflects example values in a BTIC 111 that have been trained based on the previous call to subroutine C. As shown, the table 430 specifies the target address of the subroutine (C), and the instructions located at the target address of the subroutine.

Therefore, as shown in the timing diagram 440, when A is encountered in cycle 1, the processor 101 may reference the CTC 115. Because an entry for A is included in the CTC 115 (as shown in table 420), the processor 101 “hits” in the CTC 115. The CTC 115 therefore returns the target address of the subroutine, namely C. As shown in the timing diagram 440, in cycle 2, the processor 101 may reference the BTIC 111 using the target address of the subroutine returned by the CTC 111. In doing so, the processor 101 may hit the BTIC 111 using C as the target address. The BTIC 111 may return the instructions of C, namely “Add, Sub, Add, Ld,” which the processor 101 inserts into the processing pipeline. Therefore, as shown in the timing diagram 440, stage F2 in cycle 4 includes the instructions returned by the BTIC 111. Without the instructions provided by the BTIC 111, there would otherwise be a delay to fetch the instructions from memory.

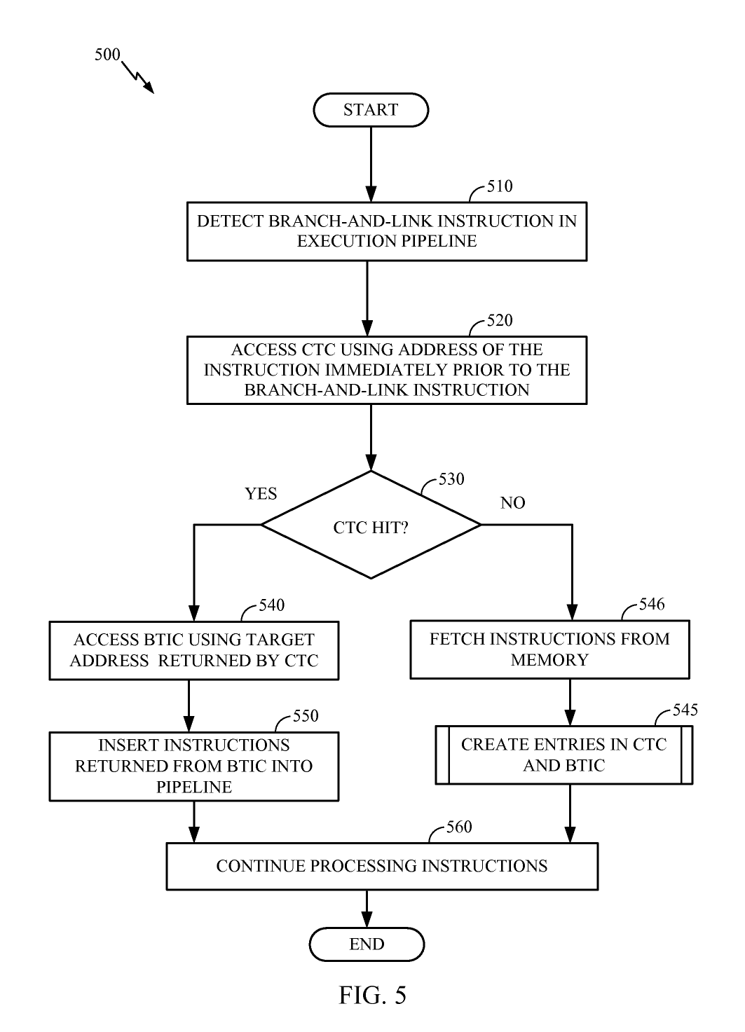

FIG. 5 is a flow chart illustrating a method 500 to eliminate redundancy in a branch target instruction cache by establishing entries using the target address of a subroutine, according to one aspect. In at least one aspect, logic in the processor 101 performs the steps of the method 500. The method 500 depicts an aspect where the call target cache (CTC) 115 is used to return the target address of a branch-and-link instruction. However, in other aspects, the target address of the branch-and-link instruction may be determined without using the CTC. For example, and without limitation, the processor 101 may determine the target address of the branch-and-link instruction call by pre-decoding instructions, decoding the instructions, and the like.

At step 510, the processor 101 may detect a branch-and-link instruction, such as a subroutine call, in an execution pipeline. As previously indicated, the processor 101 may detect branch-and-link instructions in any number of ways, including, without limitation, by decoding the instruction, pre-decoding the instruction in the instruction cache 122 and setting metadata bits indicating that the instruction is a branch-and-link instruction, and receiving an indication from a branch target address cache (BTAC) that the instruction is a branch-and-link instruction.

At step 520, the processor 101 may access the CTC 115 using the address of the instruction immediately prior to the branch-and-link instruction. As previously discussed, the processor 101 may use one or more latches to determine the program counter value corresponding to an address of an instruction immediately prior to the branch-and-link instruction in the pipeline. In at least one aspect, the address of the instruction immediately prior to the branch-and-link instruction is the program counter of the first instruction in a first set (or group) of instructions, as the pipeline may process more than one instruction per cycle. Similarly, the branch-and-link instruction may be an instruction in a second set of instructions, the second set of instructions immediately following the first set of instructions.

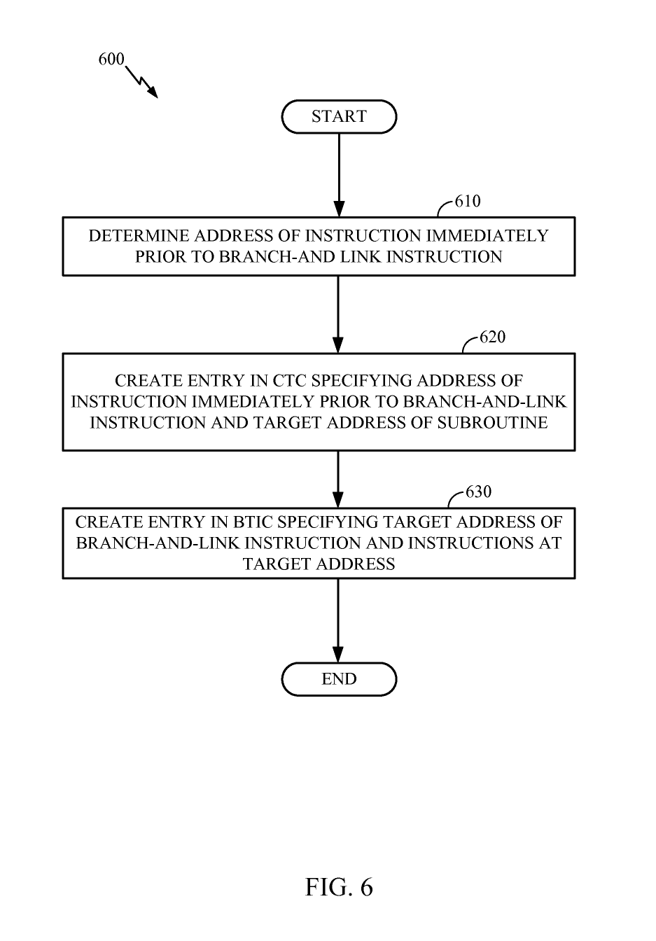

At step 530, the processor 101 may determine whether there was a hit in the CTC 115 using the address of the instruction immediately prior to the branch-and-link instruction. If the CTC 115 does not include an entry indexed by the address of the instruction immediately prior to the branch-and-link instruction, there is a CTC miss, and the processor 101 proceeds to step 543, where the processor 101 fetches the instructions from memory. The processor 101 may then proceed to step 545, described in greater detail with reference to FIG. 6, where the processor 101 creates entries for the branch-and-link instruction in the CTC 115 and the BTIC 111. The processor 101 may then proceed to step 560.

Returning to step 530, if the CTC 115 includes an entry corresponding to the address of the instruction immediately prior to the branch-and-link instruction, there is a CTC hit, and the processor 101 proceeds to step 540. At step 540, the processor 101 may access the BTIC 111 using the target address of the branch-and-link instruction returned by the CTC 115. The BTIC 111 may then return the set of instructions of the branch-and-link instruction at the target address returned by the CTC 115. At step 550, the processor 101 may insert the instructions returned by the BTIC 111 into the processing pipeline. At step 560, the processor 101 may continue processing instructions in the pipeline.

FIG. 6 is a flow chart illustrating a method 600 corresponding to step 545 to add entries to a call target cache and branch target instruction cache, according to one aspect. Generally, logic in the processor 101 may perform the steps of the method 600 to train the BTIC 111 and CTC 115 (and populate them with entries) to return instructions at the target address of branch-and-link instructions, such that the processor 101 may subsequently eliminate or reduce delays when encountering the branch-and-link instructions in program code.

As shown, the method 600 begins at step 610, where the processor 101 determines the address of the instruction immediately prior to the branch-and-link instruction. As described with reference to FIG. 2, the processor 101 may utilize latches to retain the addresses of previous instructions for several cycles. When a miss in the CTC 115 is detected, the latched address is available to create an entry in the CTC 115 for the branch-and-link instruction. In at least one aspect, the retained addresses are the program counter values for the first instructions in a respective set of instructions executed in a given processor cycle. At step 620, the processor 101 may create an entry in the CTC 115 specifying the address of the instruction immediately prior to the branch-and-link instruction and the target address of the branch-and-link instruction. At step 630, the processor 101 may create an entry in the BTIC 111 specifying the target address of the branch-and-link instruction and the instructions at the target address. Doing so allows the processor 101 to subsequently determine the target address of the branch-and-link instruction using the CTC 115, and consume the instructions from the BTIC 111 using the target address returned by the CTC 115. The processor 101 may then insert the instructions into the execution pipeline, eliminating a delay that would otherwise result when the branch of the branch-and-link instruction is taken.

A number of aspects have been described. However, various modifications to these aspects are possible, and the principles presented herein may be applied to other aspects as well. The various tasks of such methods may be implemented as sets of instructions executable by one or more arrays of logic elements, such as microprocessors, embedded controllers, or IP cores.

The foregoing disclosed devices and functionalities may be designed and configured into computer files (e.g. RTL, GDSII, GERBER, etc.) stored on computer readable media. Some or all such files may be provided to fabrication handlers who fabricate devices based on such files. Resulting products include semiconductor wafers that are then cut into semiconductor die and packaged into a semiconductor chip. Some or all such files may be provided to fabrication handlers who configure fabrication equipment using the design data to fabricate the devices described herein. Resulting products formed from the computer files include semiconductor wafers that are then cut into semiconductor die (e.g., the processor 101) and packaged, and may be further integrated into products including, but not limited to, mobile phones, smart phones, laptops, netbooks, tablets, ultrabooks, desktop computers, digital video recorders, set-top boxes and any other devices where integrated circuits are used.

In one aspect, the computer files form a design structure including the circuits described above and shown in the Figures in the form of physical design layouts, schematics, a hardware-description language (e.g., Verilog, VHDL, etc.). For example, design structure may be a text file or a graphical representation of a circuit as described above and shown in the Figures. Design process preferably synthesizes (or translates) the circuits described below into a netlist, where the netlist is, for example, a list of wires, transistors, logic gates, control circuits, I/O, models, etc. that describes the connections to other elements and circuits in an integrated circuit design and recorded on at least one of machine readable medium. For example, the medium may be a storage medium such as a CD, a compact flash, other flash memory, or a hard-disk drive. In another embodiment, the hardware, circuitry, and method described herein may be configured into computer files that simulate the function of the circuits described above and shown in the Figures when executed by a processor. These computer files may be used in circuitry simulation tools, schematic editors, or other software applications.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A method, comprising:
detecting a first instruction calling a subroutine in an execution pipeline; and
establishing a branch target instruction cache (BTIC) entry for the subroutine by writing, to the BTIC, an entry specifying a target address of the subroutine and a set of instructions at the target address.

2. The method of claim 1, further comprising:
subsequent to establishing the BTIC entry and responsive to detecting a second instance of the first instruction calling the subroutine in the execution pipeline:
receiving the target address of the subroutine using an address of an instruction previous to the first instruction;
receiving the set of instructions from the BTIC using the target address of the subroutine; and
inserting the set of instructions into the execution pipeline.

3. The method of claim 2, wherein the target address is received in a first processor cycle, wherein the set of instructions are received from the BTIC in a second processor cycle, wherein the set of instructions are inserted into the execution pipeline in a third processor cycle, wherein the first processor cycle immediately precedes the second processor cycle, wherein the second processor cycle immediately precedes the third processor cycle.

4. The method of claim 1, wherein detecting the first instruction comprises detecting the first instruction in a fetch stage in the execution pipeline, wherein the first instruction is detected by at least one of: (i) pre-decoding the first instruction, (ii) decoding the first instruction, and (iii) receiving an indication from a call target cache (CTC) that the first instruction calls the subroutine.

5. The method of claim 4, further comprising:
subsequent to detecting the first instruction, writing, to the CTC, an entry specifying an address of an instruction previous to the first instruction and the target address of the subroutine.

6. The method of claim 5, wherein the instruction previous to the first instruction is fetched in a first processor cycle, wherein the first processor cycle immediately precedes a second processor cycle, wherein the first instruction calling the subroutine is detected in the second processor cycle.

7. The method of claim 6, wherein indexing the BTIC using the target address of the subroutine eliminates redundant entries for the subroutine in the BTIC, wherein the CTC is indexed using the address of the instruction previous to the first instruction, wherein the BTIC is indexed using the target address of the subroutine.

8. The method of claim 1, wherein the first instruction comprises a branch-and-link instruction.

9. A method, comprising:
detecting a first instruction calling a subroutine in an execution pipeline;
receiving a target address of the subroutine using an address of an instruction previous to the first instruction;
receiving a set of instructions of the subroutine from a branch target instruction cache (BTIC) using the target address of the subroutine; and
inserting the set of instructions into the execution pipeline.

10. The method of claim 9, wherein the first instruction is detected by at least one of: (i) pre-decoding the first instruction, (ii) decoding the first instruction, and (iii) receiving an indication from a call target cache (CTC) that the first instruction calls the subroutine, wherein the target address of the subroutine is received from the CTC, wherein a plurality of entries in the CTC specify the target address of the subroutine, wherein each of the plurality of entries in the CTC are indexed by an address of an instruction previous to a respective instruction calling the subroutine.

11. The method of claim 10, wherein the target address of the subroutine is received from the CTC in a first processor cycle, wherein the set of instructions are received from the BTIC in a second processor cycle, wherein the set of instructions are inserted into the execution pipeline in a third processor cycle, wherein the first processor cycle immediately precedes the second processor cycle, wherein the second processor cycle immediately precedes the third processor cycle.

12. The method of claim 11, wherein the BTIC is indexed using the target address of the subroutine.

13. The method of claim 12, further comprising:
upon determining that the CTC does not include an entry specifying the address of the instruction previous to the first instruction:
returning an indication that the CTC does not include the entry for the address of the instruction previous to the first instruction;
writing, in the CTC, an entry specifying the address of address of the instruction previous to the first instruction and the target address of the subroutine; and
writing, in the BTIC, an entry specifying the target address of the subroutine and the set of instructions at the target address of the subroutine.

14. The method of claim 9, wherein the instruction previous to the first instruction is fetched in a first processor cycle, wherein the first processor cycle immediately precedes a second processor cycle, wherein the first instruction calling the subroutine is detected in the second processor cycle.

15. A processor, comprising:
a branch target instruction cache (BTIC); and
logic configured to:
detect a first instruction calling a subroutine in an execution pipeline;
receive a target address of the subroutine using an address of an instruction previous to the first instruction;
receive a set of instructions from a branch target instruction cache (BTIC) using the target address of the subroutine; and
insert the set of instructions into the execution pipeline.

16. The processor of claim 15, further comprising a call target cache (CTC), wherein the logic is further configured to:
upon determining that the CTC does not include an entry for the address of the instruction previous to the first instruction:
return an indication that the CTC does not include the entry for the address of the instruction previous to the first instruction;
write, in the CTC, an entry specifying the address of the instruction previous to the first instruction and the target address of the subroutine; and
write, in the BTIC, an entry specifying the target address of the subroutine and the set of instructions at the target address of the subroutine.

17. The processor of claim 16, wherein the CTC is indexed using the address of the instruction previous to the first instruction, wherein the target address is received from the CTC in a first processor cycle, wherein the set of instructions are received from the BTIC in a second processor cycle, wherein the set of instructions are inserted into the execution pipeline in a third processor cycle, wherein the first processor cycle immediately precedes the second processor cycle, wherein the second processor cycle immediately precedes the third processor cycle.

18. The processor of claim 17, wherein a plurality of entries in the CTC specify the target address of the subroutine, wherein each of the plurality of entries in the CTC specify an address of an instruction previous to a respective instruction calling the subroutine.

19. The processor of claim 15, wherein the BTIC is indexed using the target address of the subroutine, wherein the instruction previous to the first instruction is fetched from the address of the instruction previous to the first instruction in a first processor cycle, wherein the first processor cycle immediately precedes a second processor cycle, wherein the first instruction calling the subroutine is detected in the second processor cycle, wherein the first instruction is detected by at least one of: (i) pre-decoding the first instruction, (ii) decoding the first instruction, and (iii) receiving an indication from a call target cache (CTC) that the first instruction calls the subroutine.

20. A non-transitory computer-readable medium storing instructions that, when executed by a processor, perform an operation comprising:
detecting a first instruction calling a subroutine in an execution pipeline; and
establishing a branch target instruction cache (BTIC) entry for the subroutine by writing, to the BTIC, an entry specifying a target address of the subroutine and a set of instructions at the target address.

21. The non-transitory computer-readable medium of claim 20, the operation further comprising:
subsequent to establishing the BTIC entry and responsive to detecting a second instance of the first instruction calling the subroutine in the execution pipeline:
receiving the target address of the subroutine using an address of an instruction previous to the first instruction;
receiving the set of instructions from the BTIC using the target address of the subroutine; and
inserting the set of instructions into the execution pipeline.

22. The non-transitory computer-readable medium of claim 21, wherein the target address is received in a first processor cycle, wherein the set of instructions are received from the BTIC in a second processor cycle, wherein the set of instructions are inserted into the execution pipeline in a third processor cycle, wherein the first processor cycle immediately precedes the second processor cycle, wherein the second processor cycle immediately precedes the third processor cycle.

23. The non-transitory computer-readable medium of claim 20, wherein detecting the first instruction comprises detecting the first instruction in a fetch stage in the execution pipeline, wherein the first instruction is detected by at least one of: (i) pre-decoding the first instruction, (ii) decoding the first instruction, and (iii) receiving an indication from a call target cache (CTC) that the first instruction calls the subroutine.

24. The non-transitory computer-readable medium of claim 20, the operation further comprising:
subsequent to detecting the first instruction, writing, to a call target cache (CTC), an entry specifying an address of an instruction previous to the first instruction and the target address of the subroutine.

25. The non-transitory computer-readable medium of claim 24, wherein the instruction previous to the first instruction is fetched in a first processor cycle, wherein the first processor cycle immediately precedes a second processor cycle, wherein the first instruction calling the subroutine is detected in the second processor cycle.

26. The non-transitory computer-readable medium of claim 25, wherein indexing the BTIC using the target address of the subroutine eliminates redundant entries for the subroutine in the BTIC, wherein the CTC is indexed using the address of the instruction previous to the first instruction, wherein the BTIC is indexed using the target address of the subroutine.
